(19) United States
(12) Patent Application Publication
(10) Pub. No.: US 2007/0174121 A1
(43) Pub. Date: Jul. 26, 2007

(54) Interactive advertising methods and apparatus

(76) Inventors: Anatoliy Plotkin, Studio City, CA (US); Allan Litovsky, Huntington Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/339,864

(22) Filed: Jan. 25, 2006

(51) Int. Cl. G06Q 30/00

(52) U.S. Cl. 705/14

(57) ABSTRACT

The present disclosure concerns novel, interactive advertising methods and apparatus. Specifically, in one embodiment, the present disclosure teaches a method of advertising goods and affording customers a chance to win the advertised goods after making a payment or a donation. An apparatus comprising an advertising medium and a game facilitates the method disclosed. A novel business method is also disclosed for generating or increasing revenues from advertising by allowing consumers to interact with the advertisement by playing a game after making a payment or a donation.

### BACKGROUND

In the last century, society witnessed a dramatic increase in the advertising of goods and services. Much of the advertising offered to consumers over the last century consists of passive advertisements. The extent of the consumer's experience with the advertisement consists of looking at pictures, video clips, and listening to sales pitches. Consequently, most advertisements require only passive consumer involvement. Conversely, interactive advertising allows consumers to participate in the advertising and serves to better capture the attention of consumers and vest an interest in the goods or services advertised.

Purchasers of goods and services often wait in line to pay or wait while the transaction is being completed. Some advertising is directed at consumers who may be waiting to pay for goods or to receive services. However, such advertising is generally passive and its effectiveness is limited. Thus, a need and an opportunity exist to improve advertising methods to consumers as they wait to pay for goods, obtain services, or otherwise are available during the time when their transactions are being completed. In addition to improving the effectiveness of advertising, interactive advertising further serves to generate additional revenues from consumers who participate in the interactive advertising.

The following are expressly incorporated by reference as if fully set forth in this application: U.S. Pat. No. 6,940,393 and U.S. application Ser. No. 11/262,199.

### SUMMARY

The present disclosure concerns novel, interactive advertising methods and apparatus. Specifically, in one embodiment, the present disclosure teaches a method of advertising goods and affording customers a chance to win the advertised goods after making a payment or a donation. An apparatus comprising an advertising medium and a game facilitates the method disclosed. A novel business method is also disclosed for generating or increasing revenues from advertising by allowing consumers to interact with the advertisement by playing a game after making a payment or a donation.

According to the present disclosure, a method of generating revenue from a merchandise advertisement is taught comprising the steps of providing a gaming device, selecting an item or set of merchandise that can be earned or won, providing a display for advertising the merchandise that can be won, and allowing a consumer to play a game on the gaming device to win the merchandise.

Also disclosed by the present disclosure is a method of generating revenues comprising steps of allowing a consumer to select one or more items from a plurality of items, providing a gaming device, selecting a prize from the items selected by the consumer, and allowing the consumer to play a game on the gaming device to win the prize.

A gaming apparatus for generating revenue from advertising is also disclosed comprising, in combination, a payment collector, a game, an advertiser, an item or set of merchandise, and an inputter, wherein a customer may play the game during a transaction.

Finally, a business method for generating revenue is disclosed comprising the steps of advertising an item or set of merchandise, providing a game, accepting a payment for an opportunity to win the merchandise, and allowing a customer to play the game to win the merchandise, wherein the outcome of the game determines whether the customer wins the merchandise.

### DRAWINGS

The above-mentioned features and objects of the present disclosure will become more apparent with reference to the following description taken in conjunction with the accompanying drawings, wherein like reference numerals denote like elements and in which:

FIG. 1 is an illustration of an embodiment of the present disclosure demonstrating an advertising display and a game.

FIG. 2 is an illustration of an embodiment of the present disclosure showing a customers playing a game for an opportunity to win merchandise while transacting business at a store counter.

FIG. 3 is a flowchart demonstrating the interrelationship of an embodiment of a method for advertising merchandise and allowing a customer an opportunity to win the merchandise after making a payment.

### DETAILED DESCRIPTION

In the last century, society has witnessed a: dramatic increase in the advertising of goods and services. Much of the advertising offered to consumers over the last century consists of passive advertisements. Businesses advertised by use of billboards, magazines, televisions, radios, the internet, and other media capable of reaching consumers. The consumer experience typically involved a combination of looking at, watching, or listening to the advertisements, with no interaction or involvement. Moreover, consumers are increasingly adverse to advertisements and choose to pay for services that reduce the ability of advertisers to reach them including satellite radio services, pop-up ad blockers on their web browsers, and digital video recording devices that allow consumers to avoid watching television commercials. Thus, consumers left advertisers with the challenge of passively piquing their interest or losing sales that might otherwise be captured from a more focused audience.

Interactive advertising presents a new way to facilitate consumer participation in the advertising process. It not only serves to better capture the attention of potential customers, but may also serve to generate or increase interest in the good or service advertised. Consequently, by making advertisements more interactive, advertisers stand to generate increased revenue and interest in the products they advertise. The present disclosure is such a tool. It gives advertisers a more creative and focused method with which to pique the interests of consumers.

The design of the present disclosure allows consumers to interact with the advertising device for an opportunity to win goods or services being advertised. As a result, advertisers have a greater opportunity to pique the consumer's interest. Moreover, by requiring consumers to purchase a chance to win the good or service being advertised, the consumer stands to develop a vested interest in acquiring the good or service that they hope to win. Consequently, consumers may be induced to purchase the good or service after interacting pursuant to the present disclosure, even if they don't win it, despite lacking the original intent to make the purchase. The present disclosure therefore serves as a novel paradigm for advertising goods and services in an environment where advertisers have an otherwise increasingly difficult time reaching consumers.

The present disclosure offers for consideration interactive merchandise advertising methods and related apparatuses for advertising of goods and services. Customers, who would otherwise idly wait for transactions to complete or wait in lines and other places where customers tend to idle, may interact with advertisements of merchandise for an opportunity to win the merchandise. The methods and apparatus may require a customer to make a payment for an opportunity to win the merchandise. Once a payment is made, the customer may play a game. When the customer wins the game, the merchandise for which he or she played is awarded. The outcome of the game can be based on the customer's skill, luck, or a combination of both. It should be understood by those skilled in the art that a winning outcome of the game represents any predetermined outcome sufficient for a winning condition, such as a random occurrence, a minimum score, or a predetermined occurrence.

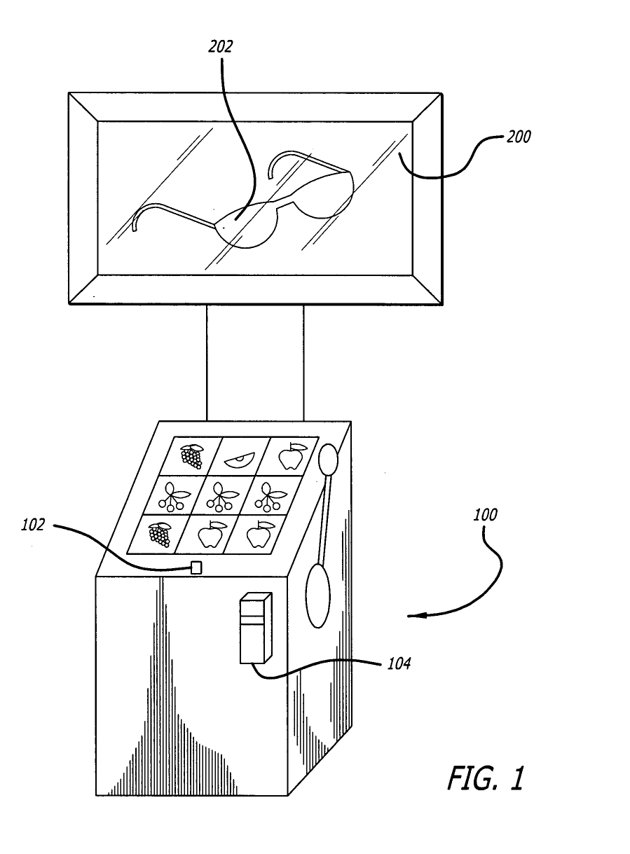

Referring now to an exemplary embodiment in FIG. 1, the present disclosure comprises game 100 and an item of merchandise 202. FIG. 1 further illustrates an embodiment of the present disclosure that allows a customer to play game 100. Advertising medium 200 may advertise merchandise 202 that may be won. Advertising medium 200 may comprise television screens, computer monitors, conventional display cases, or other advertising methods and devices that can be used for advertising merchandise 202. In the embodiment shown in FIG. 1, a television screen or computer monitor is used as advertising medium 200. The screen may be attached to the gaming device or be separate from the gaming device. Nevertheless, the screen serves to attract customers to play game 100 and attempt to win merchandise 202.

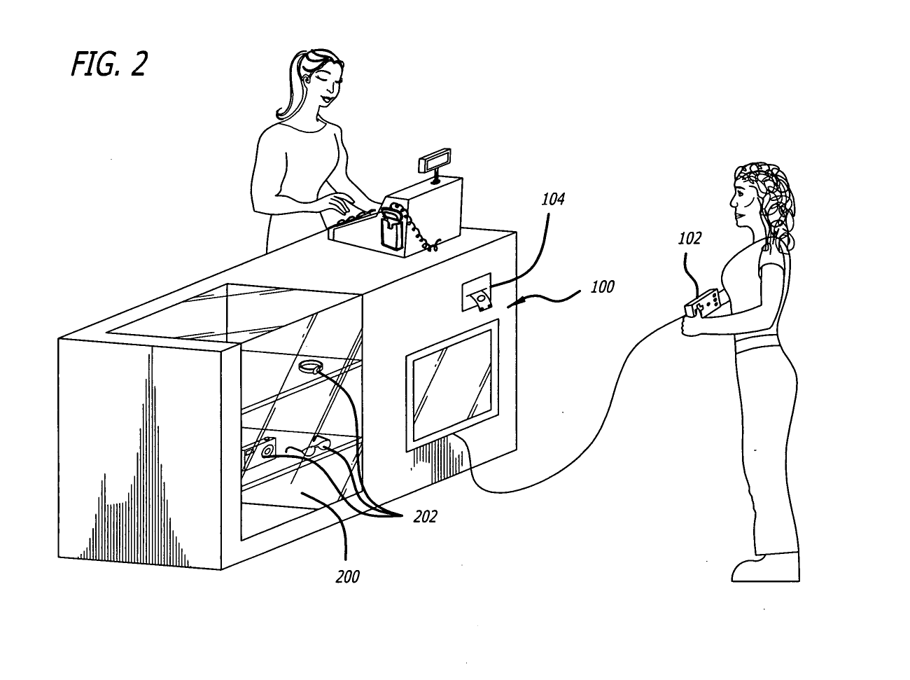

In another embodiment shown in FIG. 2, advertising medium 200 is a conventional display case. Those skilled in the art will recognize that advertising medium 200 may be any one of a number of advertising apparatuses and methods well understood and commonly used in the art.

Referring again to FIG. 1, once customers choose to compete in game 100 for merchandise 202, the customer makes a payment via money collector 104. Money collector 104 may be a bill accepter, coin accepter, credit card reader, internet payment mechanism, a person that accepts payment, or other methods of collecting payment known in the art. The user must make a payment prior to playing game 100.

Prior to playing game 100, merchandise 202 awarded on a winning outcome must be selected. Election of merchandise 202 may be accomplished in multiple ways. According to an embodiment of the present disclosure represented in FIG. 1, the merchant chooses merchandise 202 to be awarded, which may be done in conjunction with an advertisement. However, embodiments of the present disclosure contemplate allowing the customer to elect merchandise 202 for which they compete from a group of available merchandise 202 (see FIG. 2) selects merchandise 202 via inputter 102, or other buttons, touch screens, oral communications, or by using a redemption code, which on a winning condition can be redeemed at the point of transaction, by mail, by internet, or by other suitable methods. In another embodiment, election of merchandise 202 is accomplished based on the amount of payment tendered.

Once payment is made and merchandise 202 is selected, if necessary, the customer plays game 100. Game 100 may be any game well known in the art suitable for use with an advertising display, including: video games; pinball-type games; casino-type games, such as slot machines or video card games; or games popular at professional sports arenas, such as locating a stone under a plurality of shells. Other potential games include predicting the outcomes of sporting events and variations on that theme, or trying to guess a number preselected from a range of numbers. Artisans will recognize the potential for many types of games to be used in the present disclosure and will further recognize that nearly any game with an outcome that can be classified as winning will work as game 100 in the present disclosure.

The customer may interact with game 100 by using inputter 102. Embodiments of inputter 102 comprise keyboards, touch pads, joysticks, controllers, mice, or other means of interacting with games commonly known in the art.

Referring still to the embodiment illustrated in FIG. 1, game 100 may be driven by video game machines, such as video game consoles; personal computers; conventional video game machines and related apparatuses; and other games common in the art, such as slot machines or pinball machines, for example. Where appropriate, inputter 102 allows the customer to interact with game 100. However, it should be clear to one skilled in the art that inputter 102 is not a necessary element of the present disclosure, but may be included where necessary to interact with game 100.

The customer wins merchandise 202 if game 100 is won. In an embodiment, the outcome of game 100 depends on skill of the customer. Thus, the customer's skill at accomplishing the winning outcome determines whether the customer receives merchandise 202. In another embodiment, the outcome is based on the occurrence of a random event. Consequently, if the customer is lucky then he or she wins merchandise 202. Finally, an embodiment contemplates game 100 based partially on the skill of the customer and partially on luck. Generally, the outcome of game 100 will involve some degree of chance to avoid allowing skillful customers to win too often.

Merchandise 202 may be displayed as a form of advertisement. For example, merchandise 202 that may be won is shown on advertising medium 200, which is a television screen or computer monitor in FIG. 1. In FIG. 2, advertising medium 200 is a display case. Advertising medium 200 shows merchandise 202 that may be won by customers who play game 100 and win. Potential customers who are conducting transactions or waiting in a lines, for example, can view the merchandise 202 on advertising medium 200, which may entice them to make a payment via money collector 104 and play game 100.

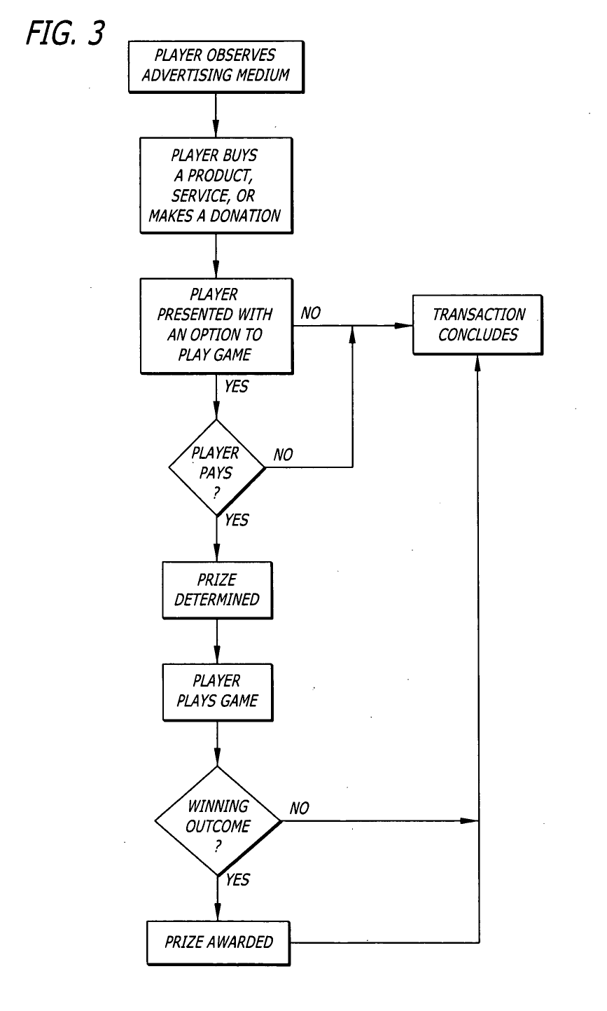

FIG. 3 demonstrates an embodiment of a method disclosed by the present disclosure. According to the method, a merchant provides game 100 and merchandise 202 that may be won to customers at the time the customer makes a purchase for a good or service, or makes a donation. In order to play game 100 and win merchandise 202, customers must make a payment via money collector 104, as previously described.

Referring an embodiment of the present disclosure represented by FIG. 3, merchants advertise merchandise 202. The advertisement may be accomplished in multiple ways and is designed to lure potential customers to make a payment and play a game for a chance to win merchandise 202. The advertising medium 200 may be a television screen or computer monitor (FIG. 1), a conventional display case (FIG. 2), or other advertising methods that would be apparent to a person skilled in the art.

Referring still to the embodiment represented by FIG. 3, advertisements are designed to attract people who are making purchases of goods or services, or making donations. At those times, customers must generally either wait in a line, wait for the transaction to complete, or both. The idle time in which the customer waits presents an ideal time to advertise to the customer and other consumers. During the waiting period, the customer may make a payment to play a game and win merchandise 202 advertised or other merchandise 202.

Payment is made to money collector 104. Money collector 104 may be a bill accepter, coin accepter, credit card reader, internet payment mechanism, or by paying a person mediating a transaction. After the payment is made, the customer may play the game and attempt to win merchandise 202. Game 100 may be any game as previously described.

Merchandise 202 may be determined in variable ways. In an embodiment, the merchant or advertiser selects merchandise 202 that may be won. In other embodiments, the customer, merchant, or random events determine merchandise 202 that may be won. For example, merchandise 202 to be won may be chosen from one of the items selected for purchase by the customer or may be an item related to one of the items selected for purchase by the customer, such as an accessory.

After merchandise 202 is determined and a payment is made via money collector 104, the customer plays game 100. If the customer wins, then the customer is awarded merchandise 202. In an embodiment, if customer does not win game 100, the customer can tender an additional payment for a second chance to win merchandise 202 or tender at least the amount necessary to purchase merchandise 202 outright.

Also disclosed by the present disclosure is a business method of interactive advertising of merchandise 202, which is designed to generate revenue from increased sales of merchandise 202 advertised or from the payments made by customers playing game 100. It should be understood by one skilled in the art that the disclosed business method requires no advertisement to generate revenue. As such, the advertisement in embodiments of the business method is optional. However, where advertising media is used, merchandise 202 or ads for other goods or services may be advertised on a television screen, computer display, in a conventional display case, or in other ways common in the art for advertising as a method of enticing customers to make a payment via money collector 104 and play game 100. As part of the advertising method, the customer has an opportunity to win merchandise 202 advertised or other merchandise 202.

According to the teachings of the business method, revenue is generated by allowing customers to attempt to win merchandise 202 after making a payment via money collector 104. In an embodiment, merchandise 202 is advertised. Customers who are attracted by the advertisement and desire to play game 100 make a payment via money collector 104 for a chance to win merchandise 202. After the payment is made, a customer is presented with game 100. According to an embodiment of the method, game 100 may be based on the customer's skill, on chance, or on a combination of the customer's skill and chance; the game may be any game as previously described.

Upon winning, the customer is awarded merchandise 202. If the customer loses, then the customer has the opportunity to pay an additional payment to play again or to purchase merchandise 202. The additional payment amount necessary to purchase merchandise 202 brings the total payment, defined as the initial payment plus the additional payment, to be at least the price necessary to purchase merchandise 202 outright.

The disclosed business method is appropriate for use with stand alone advertising displays, conventional checkouts for merchandise, internet merchandise checkout and payment mechanisms, or in other venues suitable for interactive advertising. Revenue is generated by increased sales stemming from the advertisements or payments collected when losing outcomes occur, or a combination of both.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of generating revenue from a merchandise advertisement comprising the steps of:
providing a gaming device, further comprising an advertising medium for advertising the merchandise that can be won;
selecting at least an item of merchandise that can be won; and
allowing a customer to play a game on the gaming device to win the merchandise.

2. The method of claim 1 wherein the game is a game of chance.

3. The method of claim 1 wherein the game is a game of skill.

4. The method of claim 1 wherein the gaming device allows the customer to purchase the merchandise.

5. The method of claim 1 comprising an additional step of requiring the customer to make a payment before the customer is allowed to play the game.

6. The method of claim 1 comprising an additional step of requiring the customer to purchase an item or service before the customer is allowed to play the game.

7. The method of claim 1 comprising the additional step of requiring the customer to make a donation before the customer is allowed to play the game.

8. The method of claim 1 wherein the gaming device is a computer.

9. The method of claim 5 wherein the gaming device is a computer connected to a network.

10. The method of claim 6 wherein the gaming device is a computer connected to a network.

11. The method of claim 7 wherein the gaming device is a computer connected to a network.

12. The method of claim 1 wherein the advertising medium is not an integral part of the gaming device.

13. A method of generating revenue comprising steps of:
providing a plurality of items;
allowing a customer to select one or more items from the plurality of items;
providing a gaming device having a game;
selecting a prize from the items selected by the customer; and
allowing the customer to play a game on the gaming device to win the prize.

14. The method of claim 13 further comprising a step of advertising a potential prize from the plurality of items.

15. The method of claim 13 wherein the game is a game of chance.

16. The method of claim 13 wherein the game is a game of skill.

17. The method of claim 13 further comprising an additional step of requiring the customer to make a payment before the customer is allowed to play the game.

18. The method of claim 13 further comprising an additional step of requiring the customer to make a donation before the customer is allowed to play the game.

19. An apparatus for generating revenue from advertising comprising, in combination:
a payment collector;
a game;
an advertiser;
an item of merchandise; and
an inputter;
wherein a customer may play the game during a transaction.

20. The apparatus of claim 19 wherein the transaction is a sale of a good or service.

21. The apparatus of claim 19 wherein the transaction is a donation.

22. A method for generating revenue comprising the steps of:
advertising merchandise;
providing a game;
accepting a payment for an opportunity to win the merchandise; and
allowing a customer to play the game to win the merchandise;
wherein the outcome of the game determines whether the customer wins the merchandise.
